(19) United States
(12) Patent Application Publication
(10) Pub. No.: US 2010/0274550 A1
(43) Pub. Date: Oct. 28, 2010

(54) Integrated development structure having virtual inputs/outputs for embedded hardware/software

(75) Inventors: Tsung-Yi Chou, Chia-Yi (TW); Wei-Chun Ku, Chia-Yi (TW); Che-Neng Wen, Chia-Yi (TW); Tien-Fu Chen, Chia-Yi (TW)

Correspondence Address: Jackson Intellectual Property Group PLLC, 106 Starvale Lane, Shipman, VA, 22971, US

(73) Assignee: National Chung Cheng University, Chia-Yi (TW)

(21) Appl. No.: 12/010,404

(22) Filed: Jan. 24, 2008

(51) Int. Cl. G06F 17/50

(52) U.S. Cl. 703/21

(57) ABSTRACT

With the present invention, buses and silicon IPs are simulated together. A virtual platform is provided for designing hardware and system. And correct and fast simulations of I/Os are provided through the I/Os on a FPGA. Thus, software performances are monitored and system bottlenecks are acquired.

### FIELD OF THE INVENTION

The present invention relates to a development structure; more particularly, relates to an integrated development structure having virtual inputs/outputs (I/Os) for developing embedded hardware/software (HW/SW).

### DESCRIPTION OF THE RELATED ARTS

Nowadays, system-on-chip (SoC) becomes complex in structure design and has more different applications. A process of hardware design first and software design later is no more satisfying. Thus, a HW/SW co-design is brought forth. Yet, such a design needs a prototype in an early stage to obtain information for the whole designing process without high price.

Traditionally, a register transfer level (RTL) simulation is used. But the simulation is a slow simulation. Field programmable gate array (FPGA) may also be used yet with a high cost and a limit on gate count. Hence, a solution of a fast and acute virtual platform over an electronic system level is required.

Known virtual platforms, like QEMU, VMware, hird of Unix-replacing daemons (HURD), etc., provide full simulations of different CPU models and related parallels, like keyboard, mouse, general purpose input/output (GPIO), etc. They provide system software for development with a user mode Linux or a virtual machine. However, these virtual platforms are short in considerations on hardware/software system deign level, like flexible performance statics tools, bus traffic analysis tools, silicon intellectual property (IP) design flow, etc. In addition, on integrating hardware and software, acute model and related analyzing tools are wanting. Hence, the prior arts do not fulfill all users' requests on actual use.

### SUMMARY OF THE INVENTION

The main purpose of the present invention is to simulate buses and silicon IPs together; to provide a virtual platform for designing hardware and system; and to provide correct and fast simulations of I/Os through the I/Os on a FPGA for monitoring software performances and acquiring system bottlenecks.

To achieve the above purpose, the present invention is an integrated development structure having virtual I/Os for an embedded HW/SW, comprising a CPU model accessing I/Os of a virtual platform; a performance monitoring model for obtaining a performance of a system at a system design stage; and a virtual peripheral model entering a procedure core of the virtual platform to obtain next component to be processed. Accordingly, a novel integrated development structure having virtual I/Os for an embedded HW/SW is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the structural view showing the preferred embodiment according to the present invention;

FIG. 2 is the view showing the execution flow in the CPU model;

FIG. 3 is the view showing the performance monitoring model;

FIG. 4A is the flow view showing the state of use; and

FIG. 4B is the view showing the shared memory model.

### DESCRIPTION OF THE PREFERRED EMBODIMENT

The following description of the preferred embodiment is provided to understand the features and the structures of the present invention.

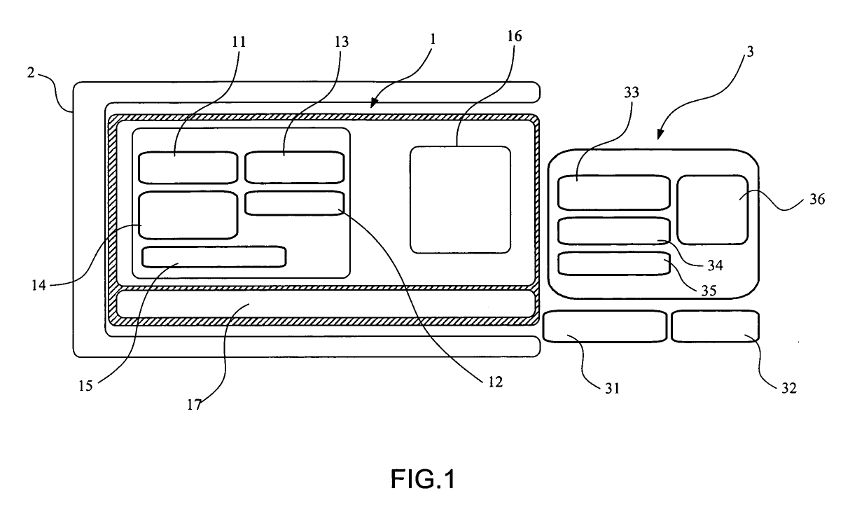

Please refer to FIG. 1, which is a structural view showing a preferred embodiment according to the present invention. As shown in the figure, the present invention is an integrated development structure having virtual inputs/outputs (I/Os) for an embedded hardware/software (HW/SW), comprising a central processing unit (CPU) model 1, a performance monitoring model 2 and a virtual peripheral model 3.

The CPU model 1 comprises a memory corresponding model 11, a debugging server 12, a code cache 13, a background dynamic binary translator 14 and an AHB master wrapper 15, where AHB stands for ARM high-performance bus, ARM for advanced RISC machine, and RISC for reduced instruction set code.

The performance monitoring model execution tracing engine 21, an event center 22, an event dispatcher 23, an event generator 24, an event tracer 25, an event logger 26 and a hardware simulation engine 27.

The virtual peripheral model 3 comprises an I/O connection controller 31, a virtual I/O checker 32, a virtual terminal 33, a virtual universal asynchronous receiver-transmitter (UART) 34, a virtual liquid crystal display (LCD) 35 and a virtual storage 36.

Thus, a novel integrated development structure having virtual I/Os for an embedded HW/SW is obtained.

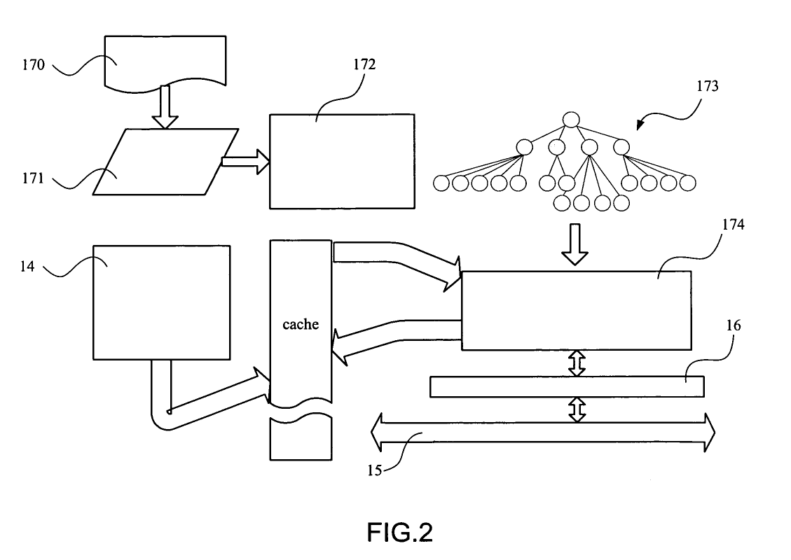

Please further refer to FIG. 2 to FIG. 4B, which are a view showing an execution flow in a CPU model, a view showing a performance monitoring model; a flow view showing a state of use; and a view showing a shared memory model. As shown in the figures, a CPU model 1 accesses I/Os of a virtual platform and is modeled through a language of System C, C++ or C to fulfill requirements of the users. Yet, different languages obtain different simulation velocities. The model obtained through C language has a fastest simulation velocity, yet has a worse cycle accuracy than that obtained through System C. Moreover, System C provides a transaction level modeling for monitoring bus load. Thus, for normalizing a bus model 16, the bus model 16 provides related wrapper interfaces for components mounted on the bus to realize a fast and easy way for mounting to a target structure. Take an AHB realized on the virtual platform as an example. When the CPU model 1 accesses a component on the AHB, a request signal conformed to AHB protocol is sent to the AHB. When the request signal arrives at the AHB, the AHB sends the request to a corresponding component, or handles the request in a proper way. And, for obtaining a simulation velocity to fulfill HW/SW development requirement, the virtual platform provides changeable velocities for the CPU model 1. Therein, the memory corresponding model 11 effectively handles inputs/outputs of the CPU model 1; the debugging server 12 provides a remote debugging interface (RDI) for debugging with a 3rd party's debugger; and, the code cache 13 and the background dynamic binary translator provide velocity changeability for the CPU model 1.

An action of ‘decoding→executing’ is constantly repeated during a simulation. Even if a code is the same as the previous code simulated, the action of ‘decoding→executing’ is still processed no matter the code has been simulated or not. However, the code cache 13 caches processed codes in the memory corresponding model 11; and, on processing a repeated code, the code is rapidly executed through looking table without decoding the code again. Then the background dynamic binary translator 14 processes a binary transformation of the code stored in the code cache 13 in a background mode during the simulation, where the code of a target platform 28 is transformed into a code of the present host platform. Furthermore, for smoothly connecting the CPU model 1 to the bus model, the AHB master wrapper 15 is provided by the CPU model 1 with changeable velocities to simulate different models together.

As shown in FIG. 2, when an instruction set file 170 enters into the CPU model 1, a processor instruction set field's description file 171 describes every field of the instruction set. An instruction set decoding tree generator 172 is coordinated with the background dynamic binary translator 14 to generate a decoding tree 173 for a processor simulator. And, an instruction set simulator 174 of the decoding tree 173 is used to effectively improve a decoding velocity. The bus model 16 and the AHB master wrapper 15 are used to simulate different models together. In addition, the code cache 13 is also used to accelerate execution velocity, where a simulated code is stored in a basic block to be directly executed for the next time without decoding. In the end, the executable code cache 13 is transformed into a code of the present host platform through the background dynamic binary translator 14.

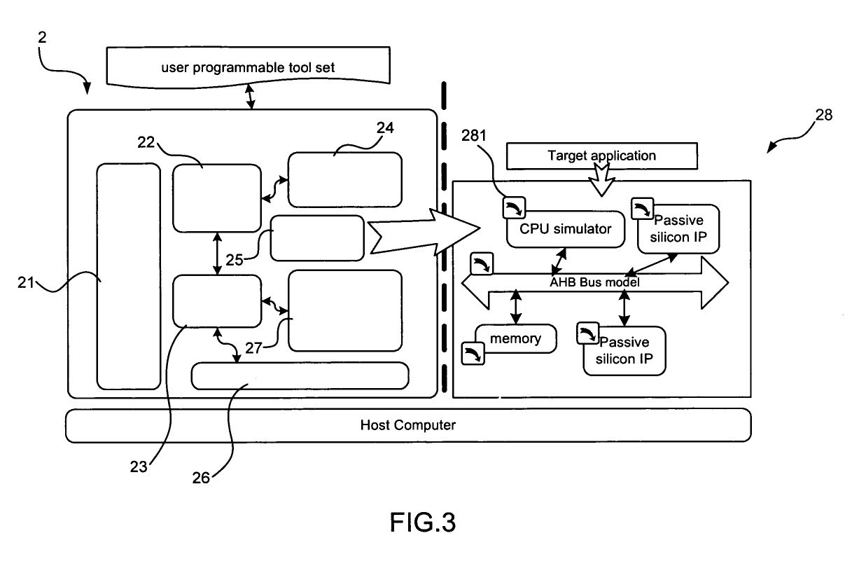

As shown in FIG. 3, for providing useful and available system performance data, the performance monitoring model 2 provides a system performance instrumentator having a software probe 281 and a target platform 28 using the system performance instrumentator. The system performance instrumentator is software for detecting system performance bottleneck at a system design stage. The software probes 281 are inserted at required places on the virtual platform, or, in applications of the virtual platform; and, the software probes are customized according to different requirements. The performance monitoring model 2 has an event-driven procedure core, where the event is the performance item to be detected and the system performance instrumentator uses the event on execution. The event generator 24 manages events to be triggered. In the CPU model 1, each program counter has two event lists recording events triggered before and after each code. The event tracer 25 has fast write-out and has a compressing event recorder. The events are self-defined and are managed by the event center 22. Related event monitoring codes are generated by the event generator 24 to be inserted into the CPU model 1 and target applications of the target platform 28; and the execution flow is controlled by the execution tracing engine 21 for triggering all monitoring through events. The event dispatcher dispatches corresponding events to the event logger 26 and the hardware simulation engine 27. For accelerating monitoring velocity and efficiency, the performance monitoring model 2 uses the customized software probes 281 to treat a part of accelerated software programs as hardware devices, where software codes are not simulated but rather treated as black boxes. The monitored traces are recorded by an event logger in a VCD-compatible format, which are also used in general waveform utilities.

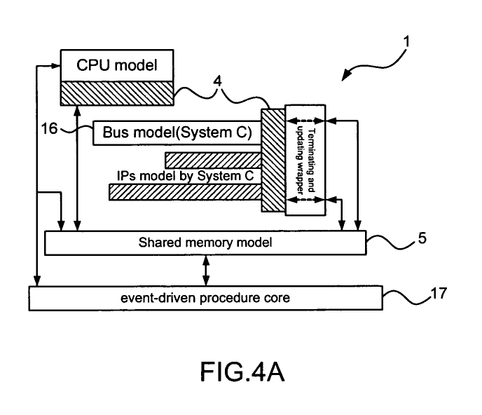

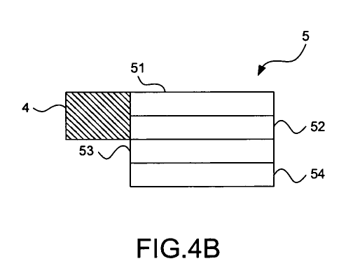

As shown in FIG. 4, the procedure core of the virtual platform is an event-oriented virtual core 5, generally shown in a graphic user interface (GUI). The event-oriented virtual core 5 inserts the software probes 281 into programs to be tested. Before accessing a code in a memory, a simulated process enters into the procedure core of the virtual platform. The event-oriented virtual core 5 of the virtual platform decides next code to be executed according to a balanced binary search tree in the CPU model. A global tick for each component on entering the procedure core is modified in the tree on leaving the procedure core for responding at an order-1 timing on obtaining next simulated component to keep balanced. And, each component on the virtual platform, such as a processor, a bus, a silicon intellectual property (IP), etc., has to realize a memory wrapper 40. Therein, the event-oriented virtual core 5 is coordinated with the simulated components through a shared memory model 4 having the memory wrapper 40. The shared memory model 4 comprises a memory space registration API (application programming interface) 41 to register a memory space for use at the procedure core; a memory configuration API 42 to define a memory configuration for a system; a memory model wrapper 43 to use a corresponding memory wrapper 40 for a System C model and to switch a flow to the procedure core on accessing a system shared memory; and a memory transaction manager 44 to manage a sequence for writing data into a memory buffer in the procedure core.

The memory wrapper 40 declares and manages the memory space and accesses the shared memory; and the simulated process enters into the procedure core of the virtual platform. Besides, for a target to be simulated with System C, the memory model wrapper 43 and a terminating and updating wrapper for the System C model are provided owing to the procedure core of the System C model. These wrappers use a wait function of System C 2.0 to switch the simulated process to the procedure core of the virtual platform.

A virtual I/O model has a set of virtual I/Os designed to connect the virtual platform to a physical platform through physical wires. The I/O connection controller 31 shown in FIG. 1 is designed and occupies a section of a memory map to be responsible for communicating with the physical platform through a virtual bus and for connecting the virtual platform to the physical platform. On accessing a wrapper of the virtual I/O on the virtual platform, the wrapper switches the bus to the virtual I/O checker 32 of the physical platform for corresponding accessing action, where the checker is used to coincide behaviors of the virtual platform with those of the physical platform. With the virtual I/Os, devices on the physical platform are directly controlled through the virtual platform without simulating System C IP or RTL (register transfer level) code, and thus development time is shortened. In this way, certification is enhanced. Because the device on the development platform obtains a driver for the physical platform with the present invention, the driver will be applicable to future use immediately without modification, and problems concerning the driver can be found beforehand for reducing development time. In addition, to enhance simulation velocity and test simplicity, the present invention provides the virtual peripheral model 3, having the virtual terminal 33, the virtual UART 34, the virtual LCD 35, and the virtual storage 36, to enter the procedure core of the virtual platform for obtaining next component to be processed. And a virtual I/O library of the platform according to the present invention has components for exchanging, where the components are compatible to an interface of the virtual I/O library.

When developing an operating system on the virtual platform, devices on the physical platform are accessed through virtual connections. On transplanting the operating system to the physical platform, the driver programs need not be modified for running on the operating system, and drivers for hardware IP can also be developed on the virtual platform. Even in the operating system on the virtual platform, drivers can be compiled to be directly mounted on the operating system for validating its correctness with time and cost saved on transplanting to the operating system.

In an early stage, software application is developed on the virtual platform; acute execution time is obtained through the virtual connection; and, software is debugged and evaluated for optimization. On developing multimedia decoding software on the virtual platform, decoded film is played on the physical platform as well as on the virtual platform; and thus an initial validation to all functions is obtained with a system-on-chip (SoC) virtual reality.

Hardware IP is obtained through the virtual I/Os with IP performance evaluated. With the IP obtained through a field programmable gate array (FPGA) on the physical platform, the IP on the physical platform is accessed to be evaluated and debugged through a virtual connection. Furthermore, through the virtual connection, transferences of internal IP signals and of communicating signals between the IP and buses are monitored for debugging in the early stage. Conclusively, with the virtual I/O, a simulated model of a hardware SoC need not be rewritten before applying to a hardware IP directly. And a hardware IP obtained on an FPGA of a hardware IP is accessed through a virtual connection on a virtual platform for constructing a whole SoC with performance bottleneck found and Internet real-time performance evaluated.

On a system level, a rapid SoC HW/SW model system is designed in the present invention for rapid performance analysis and structure tuning in an early stage on determining specification. Through a virtual platform according to such a design, a quantitative analysis is provided at a virtualization stage, and thus a correct design and allocation according to the specification is obtained for reducing development time.

The present invention accesses HW devices directly through the virtual platform with the virtual I/Os. Thus, on developing drivers for Linux system on the virtual platform, the virtual platform has the same behaviors as what the HW devices will behave. The virtual platform provides software and hardware for developing software, hardware IP, SoC architecture, drivers for Linux or other operating system, etc. Even co-design and co-verification for HW/SW can be done on the virtual platform for certification in the early stage.

To sum up, the present invention is an integrated development structure having virtual I/Os for an embedded HW/SW, where buses and silicon IPs are simulated together; a virtual platform for designing hardware and system is provided; through I/Os on a FPGA, correct and fast simulations of the I/Os are provided for monitoring software performances and acquiring system bottlenecks.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. An integrated development structure having virtual inputs/outputs (I/Os) for an embedded hardware/software (HW/SW), comprising:
a central processing unit (CPU) model, said CPU model accessing I/Os of a virtual platform;
a performance monitoring model, said performance monitoring model obtaining a performance of a system at a system design stage; and
a virtual peripheral model, said virtual peripheral model entering a procedure core of said virtual platform to obtain next component to be processed.

2. The structure according to claim 1,
wherein said CPU model comprises a memory corresponding model, a debugging server, a code cache, a background dynamic binary translator and an AHB master wrapper; and
wherein AHB stands for ARM high-performance bus, ARM stands for advanced RISC machine, and RISC stands for reduced instruction set code.

3. The structure according to claim 1,
wherein said performance monitoring model comprises an execution tracing engine, an event center, an event dispatcher, an event generator, an event tracer, an event logger and a hardware simulation engine.

4. The structure according to claim 1,
wherein said performance monitoring model inserts a software probe at a required place to monitor a performance.

5. The structure according to claim 1,
wherein said performance monitoring model inserts a software probe in a program executed on a virtual platform.

6. The structure according to claim 1,
wherein said virtual peripheral model comprises an I/O connection controller, a virtual I/O checker, a virtual terminal, a virtual universal asynchronous receiver-transmitter (UART), a virtual liquid crystal display (LCD) and a virtual storage.

7. The structure according to claim 1,
wherein said virtual peripheral model inserts a software probe into a program to be tested.

8. The structure according to claim 1,
wherein said virtual peripheral model obtains said next component through a balanced binary search tree in said procedure core.
